(19) United States
(12) Patent Application Publication
(10) Pub. No.: US 2012/0261578 A1
(43) Pub. Date: Oct. 18, 2012

(54) SCANNING LASER INFRARED MOLECULAR SPECTROMETER

(75) Inventors: David C. Scott, Pasadena, CA (US); Kelly M. Rickey, West Lafayette, IN (US); Alexander Ksendzov, La Cresenta, CA (US); Warren P. George, Valencia, CA (US); Abdullah S. Aljabri, Moorpark, CA (US); Joel M. Steinkraus, San Gabriel, CA (US)

(73) Assignee: California Institute of Technology, Pasadena, CA (US)

(21) Appl. No.: 13/160,509

(22) Filed: Jun. 15, 2011

Related U.S. Application Data
(60) Provisional application No. 61/355,051, filed on Jun. 15, 2010.

(51) Int. Cl. G01J 3/28; G01J 5/02

(52) U.S. Cl. 250/339.07

(57) ABSTRACT

An infrared laser spectrometer employs a laser and a thermoelectrically cooler detector. The spectrometer uses a monolithic ring mirror with a single aperture that serves to accept the input laser illumination and the output optical signal. The laser is tunable. The number of passes of the input laser illumination can be controlled, so as to define a laser path length. In some embodiments, the ring mirror is open to the atmosphere, and in other embodiments the ring mirror is closed from the ambient atmosphere to allow samples of known origin to be measured in the spectrometer.

### CROSS-REFERENCE TO RELATED APPLICATIONS

This application claims priority to and the benefit of co-pending U.S. provisional patent application Ser. No. 61/355,051 filed Jun. 15, 2010, which application is incorporated herein by reference in its entirety.

### STATEMENT REGARDING FEDERALLY FUNDED RESEARCH OR DEVELOPMENT

The invention described herein was made in the performance of work under a NASA contract, and is subject to the provisions of Public Law 96-517 (35 USC 202) in which the Contractor has elected to retain title.

### FIELD OF THE INVENTION

The invention relates to infrared spectrometers in general and particularly to an infrared spectrometer that employs a ring mirror.

### BACKGROUND OF THE INVENTION

In order to study Earth and planetary atmospheres a reliable and highly accurate method of detecting and measuring trace amounts of gas is needed. The inherent challenge in identifying these gases is that their concentration in the atmosphere is often 10 parts per billion (ppb) or less. Absorption spectroscopy is a viable method of detecting trace gases, but it is necessary to produce long path lengths in order to achieve the precision necessary for detection.

Multi-pass laser spectrometers, like those employing Herriott cells, create long path lengths within a relatively small space using mirrored surfaces. See D. Herriott, H. Kogelnik, and R. Kompfner, “Off-Axis Paths in Spherical Mirror Interferometers,” Applied Optics, 3, 523-6 (1964). A Herriott cell provides a long optical pathlength in order to achieve higher sensitivity. The laser beam is reflected back and forth numerous times by spherical mirrors inside the cell. Making multiple passes increases the laser pathlength so as to achieve extremely high sensitivity. The laser beam is coupled into the system via a hole or aperture defined in one mirror, the coupling mirror. By properly arranging the mirror distance, the beam exits the cell after a number of passes through the same hole but at a complementary angle, allowing easy separation of the injected input beam and the output beam. Typically, up to 200 passes can be achieved with a Herriott cell for a 200-fold increase in sensitivity. One advantage of passing the input (entrance) and output (exit) beams through the same hole provides a stable arrangement so that the system is resistant to misalignment. Herriott cells and similarly designed spectrometers serve as work horses for atmospheric research.

Multiple lasers can be used with a single spectrometer to detect many species simultaneously. Webster et al. developed the workhorse Aircraft Laser Infrared Absorption Spectrometer (ALIAS), a precision four-laser system featuring 6 inch gold mirrors with four injection holes in the coupling mirror to produce four sets of non-overlapping spot patterns on the mirror pairs. C. R. Webster, R. D. May, C. A. Trimble, R. G. Chave, and J. Kendall, “Aircraft (ER-2) Laser Infrared Absorption Spectrometer (ALIAS) for in situ Stratospheric Measurements of HCl, N₂O, CH₄, NO₂, and HNO₃,” Applied Optics, 33, 454-472, (1994). FIG. 1 illustrates a prior art ALIAS-II instrument. See D. C. Scott, R. L. Herman, C. R. Webster, R. D. May, G. J. Flesch, and E. J. Moyer, “Airborne Laser Infrared Absorption Spectrometer (ALIAS-II) for in situ atmospheric measurements of N₂O, CH₄, CO, HCl, and NO₂ from balloon or remotely piloted aircraft platforms,” Applied Optics, 38, 4609-4622 (1999). This system is routinely used to detect five or more species for stratospheric measurements. The new class of spectrometers envisioned for this project can be scaled by adding as many or as few rings as the payload mass budget will allow. While they are very useful, the mirrors and supporting optics require precise alignment. These alignments are critical for the spectrometer to function and degradation of alignment results in decreased signal to noise over the course of the flight.

FIG. 1 is an illustration showing a prior art Herriott-type cell, which uses two mirrors having surfaces that are spherical segments to reflect light between them and to create a beam path length.

S. Chernin used a ring reflector for the study of shock tube dynamics. See Chernin, S. M., “New generation of multipass systems in high resolution spectroscopy,” Spectrochimica Acta Part A, 52, 1009-1022 (1996), and Chernin, S. M., “Multipass annular Mirror system for spectroscopic studies in shock tubes,” Journal of Modern Opt. 51, 223-231 (2004). FIG. 2 is a diagram that illustrates the multiple paths traced out on the inside of a prior art ring having two apertures, one for laser beam input and one for an output beam. The number of round trips inside the annular spherical belt can be varied by changing the laser injection angle. This early design was used to demonstrate the detection of NO₂ in the visible spectrum where the absorption cross section is extremely weak for NO₂. Opto-mechanical designs that employ a spherical section can provide a nearly isothermal detection cell for the main spectrometer body. Work in this area was also demonstrated by Tonomura et al. See Tonomura et al., “An experimental study on a cylindrical multi-pass cell,” CLEO/Pacific Rim 2005. Pacific Rim Conference on Lasers and Electro-Optics, 2005., 1425-1426, (2005).

Nishimoto, et al. (2008) used a cylindrical cell having separate holes for injecting and receiving the laser beam. See T. NISHIMOTO et al., “A Compact, Cylindrical Multi-pass Cell for Sensitive Detection of Gas Absorption,” The Review of Laser Engineering, Supplemental Volume 2008, pp. 1276-1278.

Various U.S. patents and published patent applications deal with lasers and detectors useful for infrared spectrometer systems. These include U.S. Pat. Nos. 7,424,042, 7,424,042, 7,492,806, 7,535,656, 7,535,936, 7,733,925, 7,796,341, 7,826,503, 7,848,382, 7,873,094, and 7920608, and U.S. Patent Application Publication Nos. 2008/0298406, 2009/0028197, 2009/0159798, 2010/0110198 and 2010/0111122.

There is a need for an improved infrared spectrometer that is compact, robust, inexpensive and versatile.

### SUMMARY OF THE INVENTION

According to one aspect, the invention features a scanning laser infrared molecular spectrometer. The scanning laser infrared molecular spectrometer comprises a modular ring mirror having defined therein a single aperture through which an input laser beam and an output beam both pass, the modular ring mirror having defined therein an inner reflective surface configured as a section of a sphere, the modular ring mirror having defined therein a volume configured to contain a gas sample to be measured to determine at least one of a presence of a substance of interest and a concentration of the substance of interest; a laser configured to provide a beam of illumination having an intensity Iᵢₙ and a wavelength λ in the infrared, the laser aligned relative to the modular ring mirror so as to provide the beam of illumination as the input laser beam; a detector configured to detect illumination having the wavelength λ in the infrared and configured to provide at an output terminal thereof an electrical signal representative of an intensity Iₒᵤₜ of the detected illumination at the wavelength λ in the infrared, the detector aligned relative to the modular ring mirror so as to receive the beam of illumination as the output beam; and an analyzer configured to receive the electrical signal representative of the intensity Iₒᵤₜ of the detected illumination at an input terminal thereof, and to determine a result comprising at least one of the presence of the substance of interest and the concentration of the substance of interest based on the electrical signal, and configured to perform at least one of recording the result, displaying the result to a user, and transmitting the result to another apparatus for further use.

In one embodiment, the modular ring mirror is a monolithic ring mirror.

In yet a further embodiment, the modular ring mirror having defined therein a volume configured to contain a gas sample to be measured comprises a volume open to ambient atmosphere.

In an additional embodiment, the modular ring mirror having defined therein a volume configured to contain a gas sample to be measured comprises a volume closed to ambient atmosphere.

In one more embodiment, the modular ring mirror and the laser are configured to be mutually oriented so as to define an optical path length defined by the relation Path Length (PL)=(ring diameter)×(180−α)/2α and α is an angle of incidence of the input laser beam relative to a center of the single aperture of the modular ring mirror.

In another embodiment, the laser is a quantum cascade laser.

In yet another embodiment, the laser is configured to be tuned to a desired wavelength λ_{d}.

In still another embodiment, the detector is a thermoelectrically cooler detector.

In a further embodiment, the analyzer configured to perform at least one of recording the result, displaying the result to a user, and transmitting the result to another apparatus for further use is configured to transmit the result using a communication network.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is an illustration showing a prior art Herriott cell, which uses two mirrors having surfaces that are spherical segments to reflect light between them and to create a beam path length.

FIG. 2 is a diagram that illustrates the multiple paths traced out on the inside of a prior art ring having two apertures, one for input and one for output. The number of round trips inside the annular spherical belt can be varied by changing the laser injection angle.

FIG. 3A is a diagram illustrating a ray trace for a configuration using a modular ring mirror absorption cell with a 2° injection angle for the laser probe beam.

FIG. 3B is a diagram in plan orientation that shows the ray trace pattern for a modular ring mirror absorption cell that operates according to principles of the invention.

FIG. 3C is a diagram showing a detailed view of the aperture region of the modular ring mirror absorption cell of FIG. 3B with the angles α and γ illustrated.

FIG. 3D is a diagram showing a ray trace analysis for a modular ring mirror absorption cell.

FIG. 4A is an external view of a spherical cell geometry constructed inside one of the Mars Exploration Rover wheels that was validated and tested in the JPL Optical Metrology Laboratory.

FIG. 4B is an internal view of spherical cell geometry of FIG. 4A from the axel hub of the spherical cell. This system is extremely stable and robust, and resists alignment errors caused by mechanical and thermal perturbations.

FIG. 4C is a perspective view of a second generation spherical ring mirror that operates according to principles of the invention.

FIG. 5A is an image of a quantum cascade laser that offers extremely high power output in a small robust package, shown with a portion of a United States ten cent coin as a scale.

FIG. 5B is an image of another quantum cascade laser that offers extremely high power output in a small robust package, shown with a portion of a United States ten cent coin as a scale.

FIG. 5C is a diagram illustrating an open heatsink design, in which the laser is indicated by the arrow.

FIG. 5D is a schematic diagram illustrating how the output of a Fabry Perot (FP) quantum cascade laser can be selected.

FIG. 5E is a graph that illustrates the optical power at 4.6 μm as a function of current for a buried heterostructure QCL mounted epilayer down on a diamond submount.

FIG. 6 is a diagram of a spectral scan using an External Cavity Quantum Cascade Laser (EC-QCL) using Freon-125 as a test sample. The solid line is the experimental EC-QCL data and the dashed line is from the Northwest Infrared Spectral Library.

FIG. 7A is a diagram illustrating the regions of the electromagnetic spectrum that are useful for measuring some of the vibrational properties of molecules. The use of EC-QCLs allows broad tunability over the molecular fingerprint region of the electromagnetic spectrum.

FIG. 7B is a diagram showing a high resolution scan of methane from 600 to 6500 cm⁻¹. The increased absorption cross section in the Long Wave IR region of the spectrum is seen. This increased absorption enables sub part per billion detection sensitivity and resolution of ¹²CH₄/¹³CH₄ isotopomers.

FIG. 8 is a diagram illustrating an alternative cross section of a mirror geometry that is believed to be useful according to principles of the invention.

FIG. 9A is a perspective diagram showing a modular ring mirror design that allows for multiple wavelength selection, in which the modular ring mirror is configured as a single channel open system.

FIG. 9B is a schematic diagram showing the modular ring mirror of FIG. 9A configured as a closed system that operates according to principles of the invention.

FIG. 10 is a diagram in perspective showing a plurality of modular ring mirrors.

FIG. 11 is a graph illustrating the result of a spectral simulation of absorption by CO for various isotopes of carbon and oxygen at an altitude of 150 km in the atmosphere of Titan.

FIG. 12 is a graph illustrating the result of a spectral simulation of absorption by CO for various isotopes of carbon and oxygen at altitudes of 75 km and 10 km in the atmosphere of Titan.

FIG. 13 is a diagram of an embodiment of a network-capable modular ring mirror laser sensor.

FIG. 14 is a schematic diagram showing a cell phone in communication with a PicoP projector.

FIG. 15 is a schematic diagram showing a cell phone in communication with a PicoP projector having an attached modular ring mirror laser sensor.

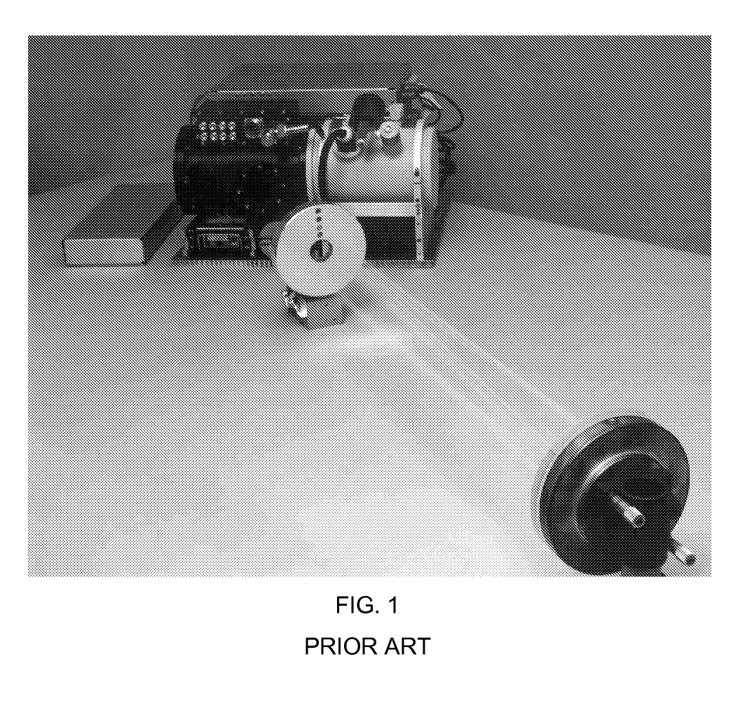

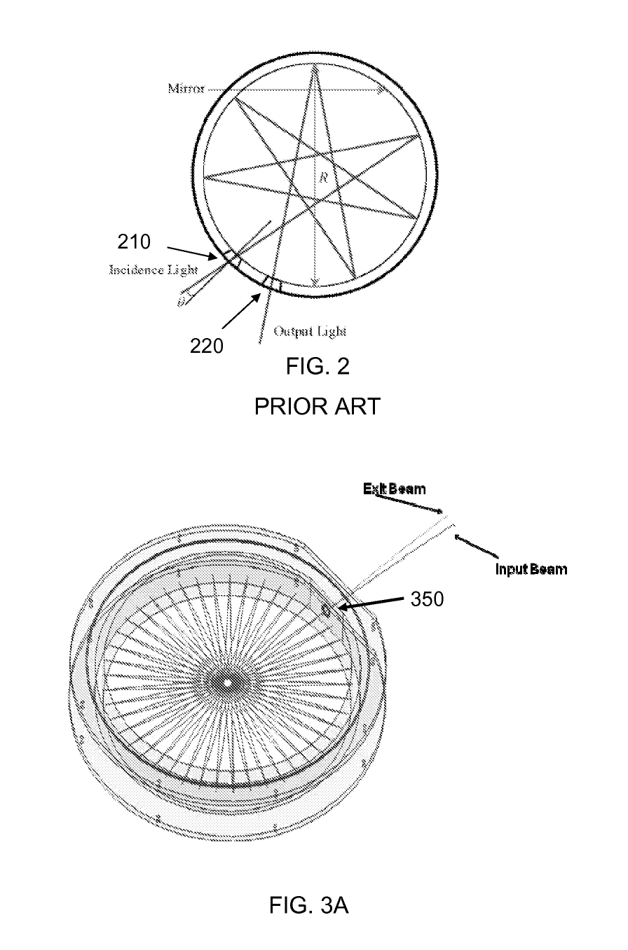

### DETAILED DESCRIPTION

### Scanning Laser Infrared Molecular Spectrometer (SLIMS)

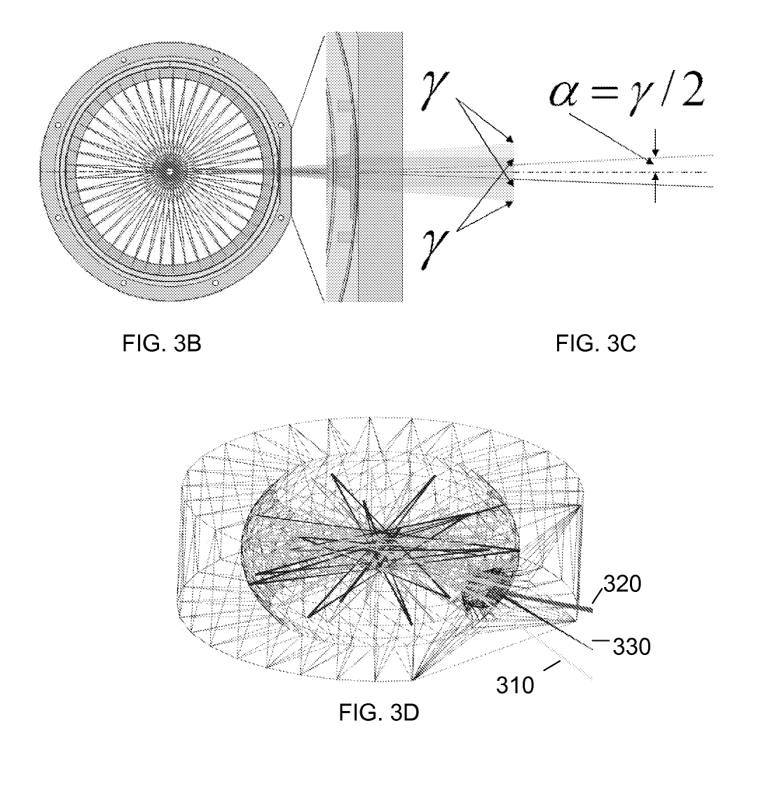

The Scanning Laser Infrared Molecular Spectrometer (SLIMS) is a spectrometer that detects and analyzes trace gas samples. SLIMS is a long path length, infrared, multi-pass, laser spectrometer capable of detecting gases at a sub part per billion level. The long path length is created using a spherical ring mirror technology that utilizes a single, solid mirror to reflect the beams as seen in FIG. 3A.

As is well known in the spectrometer arts, a spectrometer measures the presence and amount of a substance in a sample of interest by measuring the intensity of a probe signal at a wavelength known to interact with the substance under two conditions, an intensity Iᵢₙ of a input or reference beam and an intensity Iₒᵤₜ of an output beam after it has interacted with the sample of interest, and computing the absorption by the substance in the sample of interest according to Beer's Law:

Iₒᵤₜ/Iᵢₙ=exp^{(-path length×effective absorption coefficient)}

If the path length is known, the effective absorption coefficient can be computed. Path Length (PL)=(ring diameter)×(180−α)/2α and α is an angle of incidence of an input laser beam relative to a center of a single aperture in the modular ring mirror, as shown in FIG. 3C. The effective absorption coefficient is equal to a proportionality constant times the absorption coefficient for a known condition (e.g., absorption by a specimen of the substance at a known concentration at the wavelength λ under known conditions of pressure and temperature, or a “standard sample,” which absorption coefficient can be measured separately and recorded). The proportionality constant describes the relative concentration of the substance in the sample of interest as compared to the concentration of the substance of interest in the standard sample.

By creating a ring with a spherically shaped cavity and a highly polished finish, multiple bounces can be made within the mirror ‘cell’ to create a long path length. This technology is combined with compact, tunable quantum cascade lasers (QCLs) as well as thermoelectrically cooled detectors to produce a powerful yet compact sensing device for Earth and interplanetary science missions.

The Scanning Laser Infrared Molecular Spectrometer (SLIMS) is an extremely versatile laser spectrometer that achieves very long effective path lengths, which make possible ppb and sub-ppb measurements of trace gases. It can also accommodate multiple laser channels covering a wide range of wavelengths resulting in detection of more chemicals of interest. The mechanical design of the mirror cell allows for the large effective path length within a small footprint. The same design provides a robust structure which lends itself to being immune to some of the alignment challenges that similar cells face.

The design also allows one to select an optical path length by selecting the number of optical passes that a beam of radiation makes as it traverses the mirror cell. In some embodiments, fewer passes and a shorter path length can be used for samples having a higher gas density, and more passes and a longer path length can be employed as the gas density is reduced, for example as a function of height in an atmosphere above a surface of a planet. By using a variable path length, one can provide an optical system that avoids recording either a saturated signal at high gas density or a signal having too low a signal strength at low gas density.

In one embodiment SLIMS employs extremely high power and narrow spectral bandwidth Quantum Cascade Lasers (QCLs) which can operate at thermo electric cooler (TEC) temperatures. SLIMS can deliver in situ measurements of the chemical composition of a selected gas sample or an atmospheric sample with extremely high pressure resolution and sub part per billion accuracy.

Significant advances in QCLs, detectors, and ultra stable spherical optical sampling cells enable a significant advance over conventional state of the art systems. There are also other applications for these lightweight high resolution spectrometers in atmospheric, environmental, industrial, military, medical, and homeland security applications.

The modular design for the new spectrometer systems features spherical ring self-focusing optical multipass absorption cells which enable facile configuration for multichannel systems. Since each ring can be optimized for a specific spectral frequency for a specific molecule of interest, multichannel systems can be configured to detect as many or as few spectral frequencies as may be convenient. Since each optical path for the individual ring cells is physically separated from the adjacent channel, this completely eliminates cross talk or light from one channel interfering with or scattering into the adjacent channel's detection system.

### Advantages of a Spherical Cell

In this design, the ring radius can be tailored for desired sensitivity, and the mirror coating can be optimized for the frequency of interest. In this design, the radial and tangential curvatures are equal.

It is advantageous to perform a careful selection of laser frequencies o avoid spectral overlap. It is advantageous to provide an optical design that minimizes fringing. The use of high power single mode lasers is advantageous. The robust monolithic ring design offers advantages in size and weight.

The optical design includes both theoretical optical ray trace modeling and empirical validation in the Optical Metrology Laboratory (OML) at the Jet Propulsion Laboratory (JPL). Laser frequency selection can be defined and detection sensitivities modeled using the HITRAN data base. It is believed that detection of isotopic species of interest such as CH₃D/CH₄, ¹³CH₄/¹²CH₄, ¹³CO/¹²CO₃ and C¹⁸O/C¹⁶O can be accomplished. Detection of isotopic variations in trace gases can provide information about the origin of such gases, such as the geological or biological origins of the gases, and/or about the origin of a selected gas sample of interest. It is believed that the SLIMS will allow quantification of particle sizes and structures entrained in gas samples, including the simultaneous measurement and analysis of particle number densities and size distribution. It is believed that the SLIMS will allow one to determine transient vaporization of volatile liquids by using the advanced QCL spectrometer to measure an evolving vapor at high precision and accuracy.

SLIMS represents a new class of lightweight isothermal high resolution scanning laser spectrometer. The optical cavity of this new spectrometer features a spherical cavity design where the major optical structure is an annular ring that represents the equatorial section of a sphere, in which the optical rays lie in a plane. This unique design has an advantage over conventional Herriott cell designs in that there is no coefficient of thermal expansion mismatch between the mirrors, typically made out of Zerodur, and the metal mirror mounts machined out of aluminum or super Invar. Due to the monolithic design of the main spectrometer cell, expansion or contraction of the main assembly will be uniform in the three dimensions. This ensures the cell retains its self-focusing condition over a broad temperature range, yielding a robust isothermal system resistant to misalignment. Another appealing feature of this design is that it can take advantage of common ring components already available. In one example, adaptation of this design to the interior diameters of rover wheels as the mirror surface for an absorption spectrometer has been demonstrated.

By stacking the rings in series it is possible to use optimal reflective coatings for the selected laser frequencies, greatly improving the spectrometer sensitivity for multichannel systems. Conventional multichannel Herriott cell spectrometers are limited by the need to use one reflective coating for a range of target spectral frequencies.

Sample handling and processing is greatly improved with the ring design as well. The systems can be run in an open path configuration completely eliminating the need for pumps, valves, pressure regulating systems, and filtration systems. For reactive molecules and polar molecules that adhere to surfaces (e.g., water, ammonia, hydrochloric acid) this open path architecture will enable more accurate rapid real time measurement of key chemical species without the hysteresis that plagues conventional systems using inlet tubes, filters, valves, and pumping systems. It is expected that there will be no sample delivery edge effects or sticking of sample constituents to various materials in the system. As an example, accurate detection of ammonia in atmospheric samples is plagued with memory effects when spectrometer intake systems and sample cells are exposed to high concentrations of ammonia which adheres via hydrogen bonding to many metal and glass surfaces. It often takes extended periods (e.g., days or weeks) at high temperature to pump the chemical off of the spectrometer walls. The ring design can provide a clean open path for chemical sampling which is constantly purged by ambient air.

This modular ring design is ideal for a broad range of other chemical sensing applications in defense, industrial, security, medical, and environmental health applications. As we have demonstrated, the ring design can easily be incorporated into existing components, preferably circular components, such as the rim of a wheel of a vehicle, and it is expected that it can also by applied in other existing components such as process piping, HVAC systems, and smoke stack monitoring systems. Recent work in QCL spectrometry has shown great promise for detection of chemical weapons and using stacks of ring spectrometers on the air inlets for Humvees and military vehicles could provide efficient early warning for personnel. Installation in air handler intakes could provide early warning for buildings and personnel in case of chemical attack. As global climate changes become more important and monitoring of greenhouse gases reaches a critical state for the global community, ring spectrometers could provide accurate real time measurement of effluents from power plants, production facilities, and exhaust pipes for vehicles. Accurate monitoring of CO₂ emissions may be the most important challenge of our time. This SLIMS ring system provides a web of laser light to accurately and efficiently sample all emissions from exhaust systems fitted with these efficient, compact, and rugged chemical monitoring systems.

In addition to the previously recited applications, the ability to observe and identify the presence of trace gases within an environment is a paramount capability needed to advance Earth and planetary atmospheric research. It is advantageous to be able to identify the presence of specific gases and isotopologues found in planetary atmospheres within our solar system. The presence and relative amounts of these gases allows scientists to deduce history of the planetary atmosphere and the likelihood that life has or could exist there. One challenge is accurately acquiring the data needed to make reliable conclusions when some of the target gas molecules are present in trace quantities of 10 parts per billion (ppb) or less. Laser gas spectrometers are effective ways of collecting in situ gas measurements, but their precision is directly proportional to the path length of the optical system.

### Nonterrestrial Applications

In planetary exploration, two targets of particular interest are the planet Venus and Saturn's moon, Titan. Both of these bodies contain dense atmospheres thicker than that of Earth; and each has unique characteristics that make them prime scientific targets.

Titan is the second largest moon in the solar system and the only moon to contain a significant atmosphere. This moon's atmosphere (composed of ˜98.4% nitrogen and ˜1.6% methane as well as other trace gases) is the only body besides Earth in our solar system containing a nitrogen rich atmosphere. Large amounts of methane, and trace amounts of the chemical building blocks of amino acids exist as well. Their presence on Titan leads scientists to liken the moon to Earth before the presence of oxygen-producing bacteria. By measuring the types and specific amounts of these trace gases a better understanding can be gained as to how they were formed. Methane specifically can be created through many different processes; therefore, identifying the origins of Titan's methane is a key to understanding the moon as a whole. In the same way water exists as a liquid and a gas on Earth, lakes of liquid methane exist on Titan's surface. Some scientists believe that if methane producing microbes do exist on Titan, then these lakes would be their most likely place of residence. Future missions to Titan will explore this possibility by closely examining these lakes and their composition. Much like Earth, Titan also has global weather patterns. Methane clouds occur over the surface daily and winds circulate in the same direction as the moon rotates. Studying weather patterns are another way of understanding change on Titan.

An artist's concept of a Montgolfier balloon probing the atmosphere of Titan is illustrated, for example, in A. Coustenis et al., “Titan Saturn System Mission In Situ Science and Instruments,” OPFM Instrumentation Workshop, Monrovia, Calif., Jun. 3, 2008.

Changes in weather show how an environment is changing and contribute to its evolution. The landscape of the moon is sculpted by winds and liquid methane erosion; both predominantly weather dictated processes. It is believed that heavy methane storms on Titan are seasonal and only commonly occur in specific latitudes, but light methane drizzles are common over the entire planet at any time. When exploring the makeup of other bodies in our solar system, water is a resource that is commonly sought. Liquid water especially is sought since it occurs so rarely in large amounts other than on Earth. Titan's surface temperature hovers around −180° C. and any trace of water could only exist as ice. However, there is evidence that beneath the surface where the temperature is warmer, there is liquid water. Water on Titan functions much in the same way that lava does on Earth: it stays liquid until it is forced to the surface where it forms cryogenic volcanoes. The water comes in contact with the cold atmosphere and quickly hardens and freezes into icy mountains and flood plains.

Venus is the closest planet to Earth and the two planets have several important characteristics in common Venus is only slightly smaller than Earth and resembles it in overall chemical makeup and in gravitational pull. Unlike Earth, Venus' atmosphere is composed of ˜96.5% CO₂, ˜3.5% N as well as trace amounts of other compounds including water vapor, sulfur dioxide and sulfuric acid. The surface temperature of Venus stays relatively constant at 461° C. with a pressure of 93 atm. In the mid and upper atmosphere it rains sulfuric acid; however, because of the high surface temperature it evaporates before reaching the surface. Scientists believe that Venus used to be a planet very similar to Earth with large bodies of water and a very similar atmosphere. However, it is speculated that the oceans evaporated and the water vapor turned into CO₂ and H₂, the latter escaping into space. The geological processes and makeup of Venus and Earth are similar with the exception there being a lack of plate tectonic activity on Venus. This difference is expected to have played a role, at least in part, in Venus' lack of large bodies of water, its high temperature, and its insufficient magnetic field to provide shielding from solar radiation. Future studies of Venus will likely focus on developing a better understanding of the geothermal processes that occur on and beneath the planet's surface. In addition to this, chemical interactions that occur in the atmosphere of Venus will be studied in greater detail. Through observation of the concentrations of trace gases that exist at different atmospheric elevations, patterns can be seen which might explain how the atmosphere is changing and at what rate. With this information further speculation can be made as to how a possibly Earth-like planet evolved into the hot and barren one that exists today.

### Analytical Description of the Spherical Ring Mirror

Recent advances using QCLs can be used to detect both broad and narrow absorption features using either direct or second harmonic detection, depending on the target. For species of interest with narrow absorption features, laser line widths of ˜100 kHz are possible to provide selectivities far superior to those obtained in conventional spectrometers. This extremely narrow line width in combination with reduced sampling pressures is expected to allow clear separation of isotopic species of interest.

In an ultra stable spherical ring, at narrow laser injection angles of less than 2 degrees, it is possible to obtain extremely long path lengths, over tens of meters, for ring diameters of less than half a meter. The long path lengths enable sub part per billion detection sensitivities for numerous chemical signatures of interest in planetary exploration. See FIG. 3A through FIG. 3D.

FIG. 3A is a diagram illustrating a ray trace for a configuration using the spherical ring mirror absorption cell with a 2° injection angle for the laser probe beam.

FIG. 3B is a diagram in plane orientation that shows the ray trace pattern for a modular ring mirror absorption cell that operates according to principles of the invention.

FIG. 3C is a diagram showing a detailed view of the aperture region of the modular ring mirror absorption cell of FIG. 3B with the angles α and γ illustrated. The angle of incidence is denoted by α (away from the reflector's center). The angular size of the input and exit beams is denoted by γ.

The relationship between the beam injection angle α, the beam angular size γ, and the number of passes through the cell are now described. The number of passes N in the annular reflector of the multipass system can be determined from the following equation:

N=(180−α)/2α (1)

The beam runs almost one-half of a circle through the cell as shown in FIG. 3B. The first reflection occurs 2α away from the radius clockwise. Each next reflection after a double pass moves the reflection by 4α clockwise. Thus the beam moves in a clockwise direction by 2α per pass; hence the 2α in the denominator in Eq. 1. In addition, the output beam is offset by a counterclockwise from the center. This accounts for the −α term in the numerator of Eq.1. The maximum number of passes is determined by the injection angle \tilde{α}smaller injection angles lead to a greater number of passes. The choice of [symbol] however, is constrained to 2α>γ, which assures that two different beam passes do not overlap and are not detected at the output simultaneously. Thus the maximum number of passes in the ring cell becomes

Nₘₐₓ=(180−γ/2)/γ. (2)

For the specific example using a single injection hole illustrated in FIG. 3C, with an injection angle of 2 degrees from the ring center, and assuming a narrow enough beam, the number of double passes converges to 45 (actually, N=(180−2)/4=44.5) so a has to be adjusted down a little to obtain exactly 45 passes.

As the injection angle approaches 0° the number of passes approaches infinity. The useful limit for the spectrometer design is a function of the ring diameter, beam diameter, divergence, and the injection hole geometry. The maximum number of useful passes can be determined theoretically using ray trace models and can be verified empirically in the laboratory using well defined laser injection angles and well controlled beam divergence parameters.

FIG. 3D is a diagram showing a ray trace analysis for a modular ring mirror absorption cell having a gold IR reflective surface, a ZnSe window, and configured to provide approximately 69 cell passes, with a diameter of approximately 60 mm, to provide a path length of approximately 4.2 m. Beam 320 is the input beam, beam 330 is a back reflection beam from the ZnSe window and 310 is the output beam.

### EMBODIMENTS

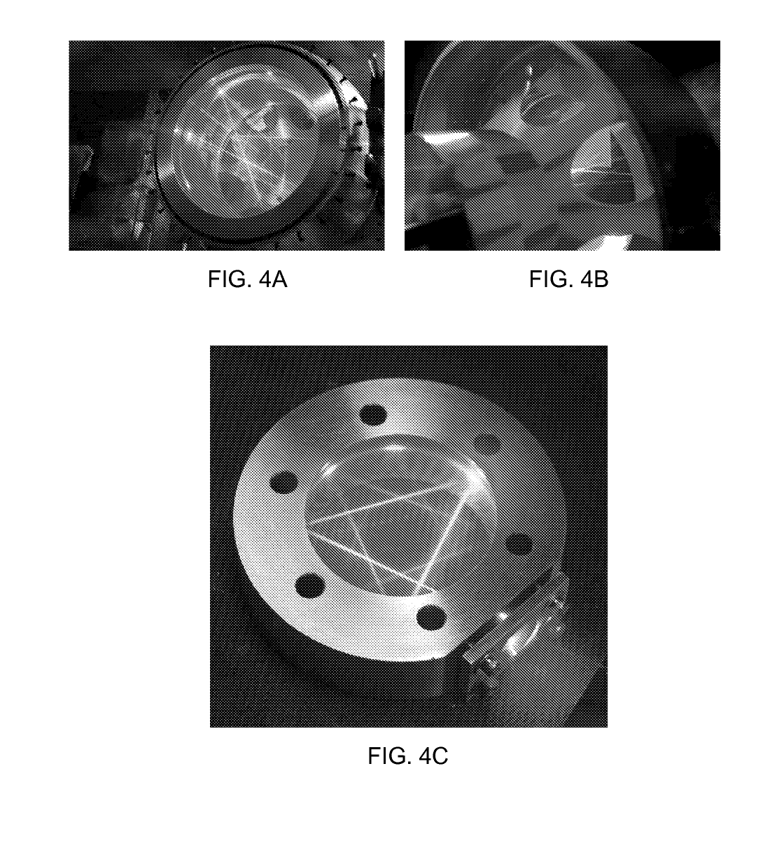

FIG. 4A is an external view of a spherical cell geometry constructed inside one of the Mars Exploration Rover wheels that was validated and tested in the JPL Optical Metrology Laboratory. This first generation geometry has a polished aluminum surface with a 188 mm inner diameter. The spherical ring mirror weighs 3986.2 grams.

FIG. 4B is an internal view of spherical cell geometry of FIG. 4A from the axel hub of the spherical cell. This system is extremely stable and robust, and resists alignment errors caused by mechanical and thermal perturbations.

FIG. 4C is a perspective view of a second generation spherical ring mirror having an electroplated nickel and gold polished inner surface with a 50 mm inner diameter. The second generation spherical ring mirror weighs 161.1 grams.

The robust design also affords a solid surface to which other components of the spectrometer can be anchored. Optically, the ring mirror design provides an exceptionally long path length for a minimum footprint, volume and mass requirement. A stack of four rings capable of operating four different channels, each with a diameter of 0.5 m and a height of 0.015 m could weigh as little as 0.4 kg and conservatively produce an effective path length of more than 50 m.

In creating a longer path length, more of the laser's initial signal is absorbed by the sample's gas particles. If too little is absorbed, the change will be unobservable. Conversely, if there is too much absorption at a specific frequency, all of the energy will be absorbed and no meaningful information will be obtained.

In many cases open air cells are used to take measurements of atmospheric gases. The gas that moves through the cell is analyzed, and thus the sample is constantly changing. Open air cells are simpler because they don't require pumps to insert the sample or to evacuate the cell before a new sample. See, for example, D. C. Scott, R. L. Herman, C. R. Webster, R. D. May, G. J. Flesch, and E. J. Moyer, “Airborne Laser Infrared Absorption Spectrometer (ALIAS-II) for in situ atmospheric measurements of N₂O, CH₄, CO, HCl, and NO₂ from balloon or remotely piloted aircraft platforms,” Applied Optics, 38, 4609-4622 (1999). More measurements can also be taken with an open cell because there is always a new sample entering the cell. Less attractive, however, is the fact that an open cell gives one no control over the sample. Pressure, concentration and other properties of the gas cannot be controlled with an open cell.

Another challenge of an open cell is maintaining the surface quality of the mirror. The mirror has a highly polished surface and typically has several coatings to minimize the loss per bounce and maximize reflection. As the quality of the surface finish increases, so does the number of passes that can be made with the same amount of loss. As mentioned previously, the number of passes is directly proportional to the precision of the measurement being made. If the mirror quality is degraded, precision is also lost. In conditions where there are heavy winds, the mirror surfaces of an open cell are vulnerable to any solid particles that hit them and can be damaged. In some circumstances, if an open cell is to be used the mirror surface may require a coating to protect it from exposure to the environment while maintaining high reflectivity.

### Tunable Quantum Cascade Lasers and Slims

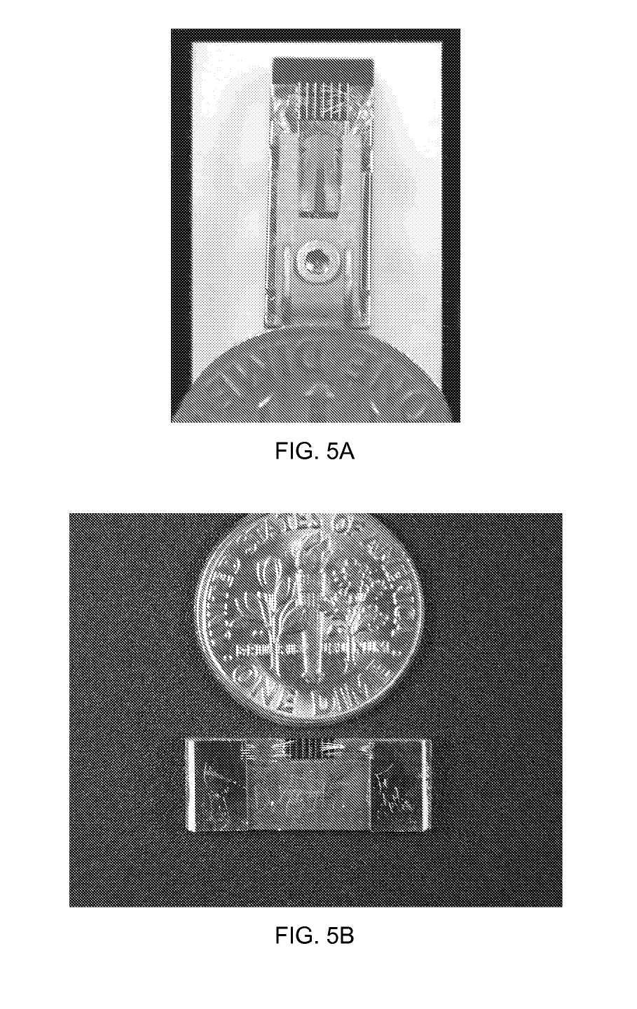

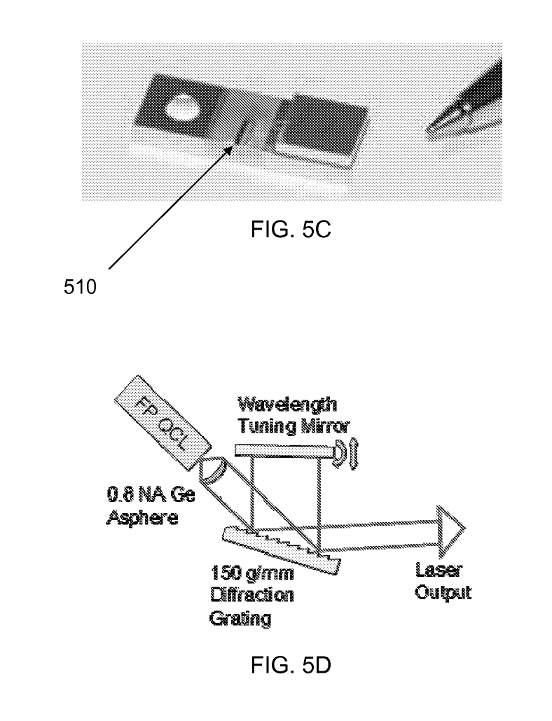

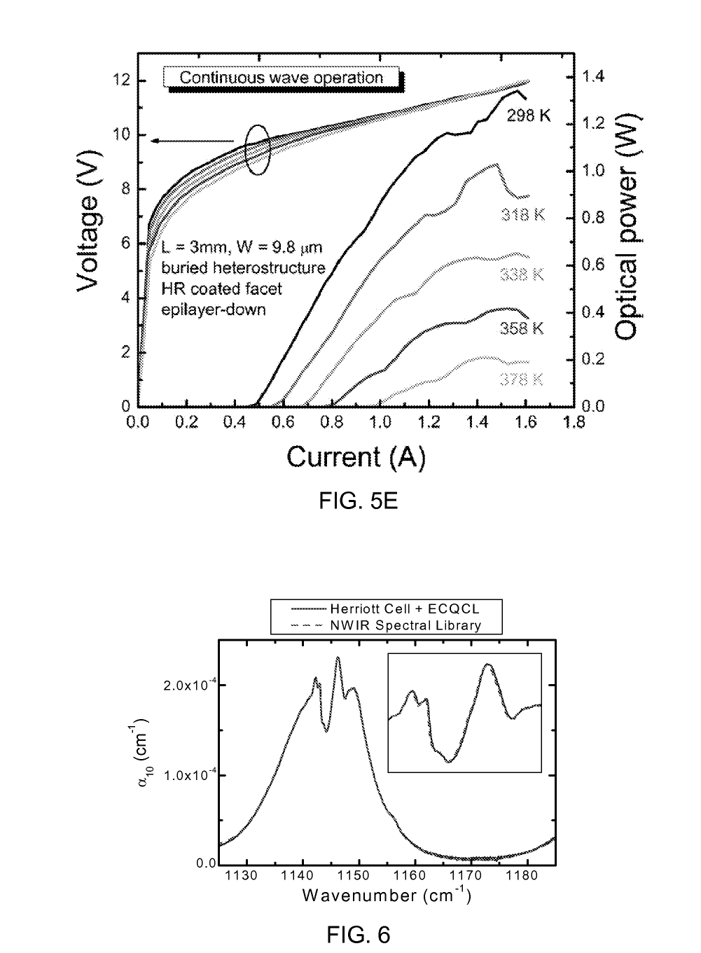

QCLs are an improvement on previous generations of lasers in many respects. QCLs are created by molecular beam epitaxial deposition of atomized layers of materials onto a wafer to create a lasing material. See F. Capasso, C. Gmachl, D. L. Sivco, and A. Y. Cho, “Quantum cascade lasers,” Phys. World 12, 27-33 (1999). By varying the thicknesses of the layers and the layer composition the wavelength of the laser can be customized over a wide range in the mid to far infrared region. The benefits of QCLs are extensive. They can be packaged in volumes smaller than a dime as shown in FIG. 5A and FIG. 5B, yet still have a high output power. QCLs are also very durable in their design. They are not static sensitive or structurally fragile. Further improvements have made them even more attractive for scientific use.

FIG. 5A is an image of a quantum cascade laser that offers extremely high power output in a small robust package, shown with a portion of a United States ten cent coin as a scale.

FIG. 5B is an image of another quantum cascade laser that offers extremely high power output in a small robust package, shown with a portion of a United States ten cent coin as a scale.

One advantage of QCLs is their small size. The chip shown in FIG. 5B is built with 7 lasers on it. This improvement alone is very valuable because of the space it saves. QCL development has also reached a point where the lasers no longer need to be cryogenically cooled but can use thermoelectric coolers. QCLs are also tunable. This means that one laser can be made to emit photons at different wavelengths by either varying the temperature or by varying the drive current. QCLs are very durable and are not susceptible to damage due to vibrational movement or static electricity.

FIG. 5C is a diagram illustrating an open heatsink design, in which the laser 510 is indicated by the arrow.

FIG. 5D is a schematic diagram illustrating how the output of a Fabry Perot (FP) quantum cascade laser can be selected.

### Quantum Cascade Lasers

QCLs have been demonstrated to be robust semiconductor devices with excellent spectral and radiant stability and can be designed to emit between 3.5 μm and 24 μm. High output powers have been achieved even for continuous wave operation at room temperature. Room temperature operation of QCLs greatly reduces the size and weight requirements for laser spectrometers by removing the large liquid nitrogen Dewar systems required for cooling, allowing a more compact system to be developed.

FIG. 5E is a graph that illustrates the optical power at 4.6 μm as a function of current for a buried heterostructure QCL mounted epilayer down on a diamond submount. The design enabled >1.3 W of output power at relatively low operating currents, e.g., below 1.6 A.

Advancements in technology now enable operation of QCLs with thermoelectric coolers, which eliminates the need for cryogenic cooling and the associated operational limitations and expense. Recent research has also led to the development of broadly tunable QCLs. By varying the input voltage and coupling to an external cavity the output wavelength can be altered up to 10% off of the center wavelength. Broadly tunable or fixed wavelength mid-infrared (mid-IR) laser sources are available from Daylight Solutions Inc., 15378 Avenue of Science, Suite 200, San Diego, Calif. 92128. For SLIMS this means less mass and longer operational life due to cryogen free cooling. Broad tunability will allow the detection of multiple gas species using a single channel, thus reducing the need and cost of adding multiple channels. Operation over broad spectral ranges now also enables detection of larger chemical species, which have very broad absorption features in the infrared spectral region as shown in FIG. 6. S. W. Sharpe, T. J. Johnson, R. L. Sams, P. M. Chu, G. C. Rhoderick, and P. A. Johnson, “Gas-Phase Databases for Quantitative Infrared Spectroscopy,” Applied Spectroscopy, Vol. 58, Number 12, 1452-1462 (2004).

FIG. 6 is a diagram of a spectral scan using an External Cavity Quantum Cascade Laser (EC-QCL) using Freon-125 as a test sample. The solid line is the experimental EC-QCL data and the dashed line is from the Northwest Infrared Spectral Library.

One advantage that QCLs have in relation to detection of chemical species is the infrared range in which they operate. In different regions of the infrared spectrum the molecules are bent and stretched differently. The magnitude of the deformations that occur as the wavelength increases absorb more energy due to stronger absorption cross sections thus making detection of trace gases easier.

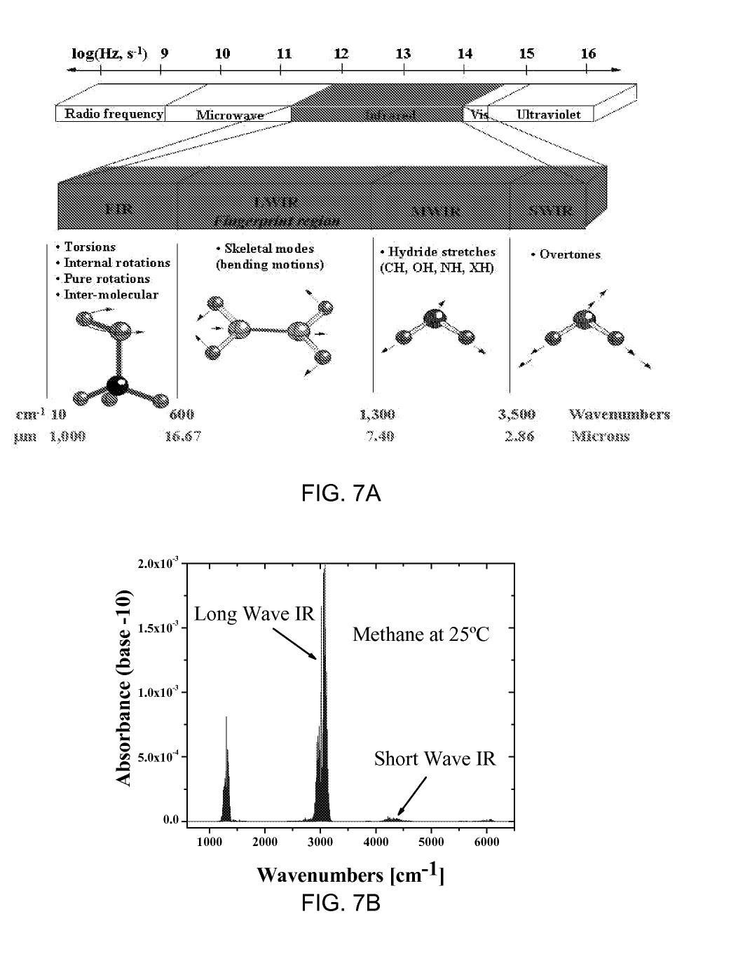

Many chemical species exhibit strong characteristic absorption features in the long-wave infrared (LWIR) region of the electromagnetic spectrum. These absorptions in the LWIR are orders of magnitude greater than in the visible or short wave infrared region and usually are far more specific, as shown in FIG. 7A and FIG. 7B. By combining high power lasers and ultra stable electronics that have been developed at JPL with multi-pass cells to increase the absorption path length, we can achieve unprecedented levels of sensitivity, sub part per billion by volume (ppbv), for detection of selected chemicals.

FIG. 7A is a diagram illustrating the regions of the electromagnetic spectrum that are useful for measuring some of the vibrational properties of molecules. The use of EC-QCLs allows broad tunability over the molecular fingerprint region of the electromagnetic spectrum.

Even within the spectrum some wavelengths are more useful than others. FIG. 7A shows the types of movements are induced by photons of light from different ranges of wavelengths in the infrared region. Close to the microwave region with longer wavelengths the molecules twist or bend. As the wavelengths get shorter the molecular bonds begin to stretch. The energy needed to stretch the molecular bonds is much greater than that needed for torsion or bending.

This is very useful for detecting the presence of small amounts of gas because more energy is absorbed by each molecule and thus a noticeable difference can be detected even with a small amount of gas present

FIG. 7B is a diagram showing a high resolution scan of methane from 600 to 6500 cm⁻¹. The increased absorption cross section in the Long Wave IR region of the spectrum is seen. This increased absorption enables sub part per billion detection sensitivity and resolution of ¹²CH₄/¹³CH₄ isotopomers.

Table I lists some of the species that are expected to be observable using the SLIMS technology.

TABLE I

| Species measured | | Precision | Accuracy* | |
|---|---|---|---|---|
| (Name) | Formula | (ppbv) | (ppbv) | Time (s) |
| Nitrous oxide | N₂O | 1.0 (±1%) | 10 (±5%) | 3 |
| Methane | CH₄ | 10 (±1%) | 50 (±5%) | 3 |
| Carbon monoxide | CO | 0.2 (±2%) | 0.5 (±5%) | 3 |
| Hydrochloric acid | HCl | 0.1 (±5%) | 0.15 (±10%) | 30 |
| Nitrogen dioxide | NO₂ | 0.05 (±5%) | 0.10 (±10%) | 30 |

*Weighted for expected signal to noise ratios for 100 ppbv N₂O, 1.0 ppmv CH₄, 10 ppbv CO, 2.0-ppbv HCl and 1.0-ppbv NO₂ at 25 km.

A distributed feedback (DFB) quantum cascade laser (QCL) has a distributed Bragg reflector (DBR) built on top of the waveguide to prevent it from emitting at other than the desired wavelength. This forces single mode operation of the laser, even at higher operating currents. DFB lasers can be tuned chiefly by changing the temperature, although an interesting variant on tuning can be obtained by pulsing a DFB laser. In this mode, the wavelength of the laser is rapidly “chirped” during the course of the pulse, allowing rapid scanning of a spectral region. A paper that describes these lasers is Faist, Jérome; Claire Gmach1, Frederico Capasso, Carlo Sirtori, Deborah L. Silvco, James N. Baillargeon, and Alfred Y. Cho (May 1997), “Distributed feedback quantum cascade lasers,” Applied Physics Letters 70 (20): 2670. Another paper that discusses the use of QCLs is “Quantum-cascade lasers smell success,” Laser Focus World, PennWell Publications, (Mar. 1, 2005).

A DFB-QCL can be tuned. The operation range of the device is −30 C to. +30 C (dT=60K). The relative tuning is constant for all wavelengths and is about 6E-5/K for wavelength and −6E-5/K for wavenumber. This results in a tuning range of about 0.4% of peak emission wavelength or wavenumber.

For a 1500/cm device, the total tuning is approximately given by

6E⁻⁵/K×60K×1500/cm≈−5.4/cm.

The relative tuning has a minus sign for wavenumbers and a positive sign for wavelength. This is exactly opposite to how a lead-salt device would tune, for those accustomed to this type of devices.

Short enough pulses will lead to Fourier limited line width. For intermediate pulse length, the limiting factor is the thermal tuning of the device. The device heats up during the pulse and its emission wavelength follows and sweeps through a range as explained above. Advantageously, pulses of 5 to 15 ns will enable one to get a minimal linewidth.

A presentation by M. S. Zahniser of Aerodyne Research, Inc., entitled “Atmospheric Trace Gas Measurements with Pulsed-Quantum Cascade Lasers: sub-ppb Ammonia Detection,” given at the Fraunhofer IPM QC Laser Workshop, February 2001, describes measured line width in pulsed operation. The standard measurement setup permits one to verify that the laser is single mode i.e., has a linewidth not exceeding 0.3 cm⁻¹.

Laser manufacturers who can supply lasers that are useful for the present technology include: Alcatel Thales III-V Lab, Route de Nozay, 91460 Marcoussis, France, Hamamatsu Corporation, 360 Foothill Rd, Bridgewater, N.J. 08807, USA and Adtechoptics, 18007 Cortney Court, City of Industry, Calif. 91748, USA.

### Thermoelectrically Cooled Detectors

As lasers became more advanced, detectors became the limiting factor. Even though QCLs could operate without liquid nitrogen, detectors still required cryogenic cooling to operate at the desired precision. SLIMS uses a new type of detector that was developed in response to the need for non-cryogenic dependent systems. Like the QCLs, these detectors can make precision measurements using thermoelectric coolers. SLIMS incorporates thermoelectrically cooled detectors allowing the spectrometer to operate independently of cryogenic cooling. The result is a spectrometer capable of long term fully autonomous missions.

### Alternative Mirror Embodiments

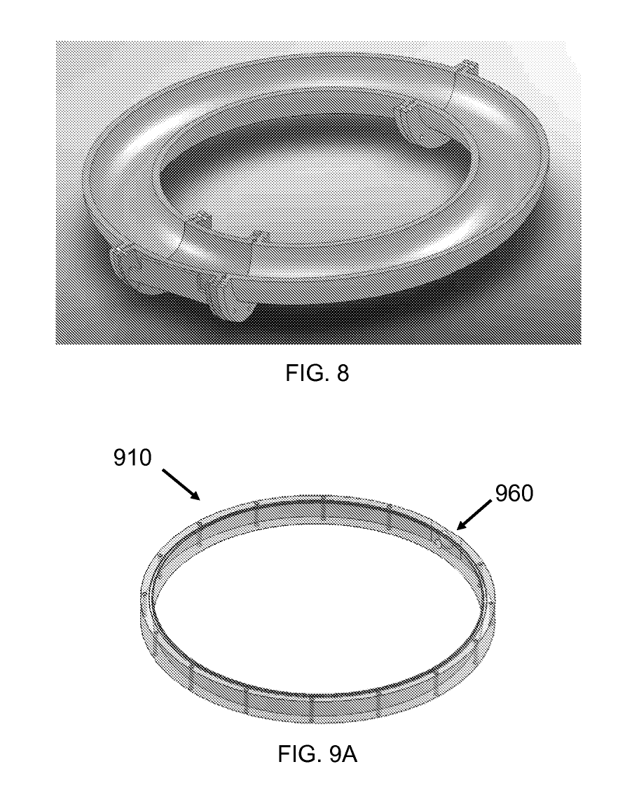

Continuing development of spherical mirrors must focus on improving the mounting technology and the beam shaping optics required to achieve precise optical alignment for the long path geometries. Purely spherical cavity mirrors can only sustain ray paths in a single plane such as those shown in FIG. 3. Use of non-spherical geometries, such as ellipsoids and curved cylinders, theoretically should allow out-of-plane ray trace solutions. Such technology could increase the effective path length even more. FIG. 8 is a diagram illustrating an alternative cross section of a mirror geometry that is believed to be useful according to principles of the invention.

It is believed that non-spherical mirrors can be developed using optical ray tracing equations to predict beam paths within the cell. Mirror surface quality and laser power are important factors in developing longer effective path lengths. For all configurations, more beam passes mean more instances of lost power when the beam is reflected by the mirror. High surface quality of the mirrors can minimize these losses and maximize the number of allowable passes. Using higher-powered lasers in the cell will allow more passes.

### Applications

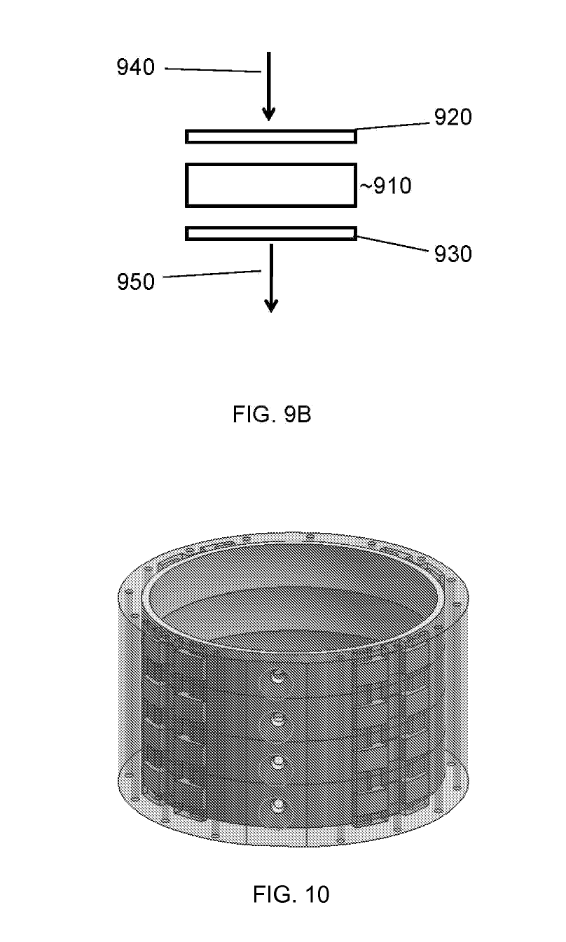

FIG. 9A is a perspective diagram showing a modular ring mirror design that allows for multiple wavelength selection, in which the modular ring mirror 910 is configured as an open system. A single aperture 960 is provided for both laser beam input and laser beam output.

FIG. 9B is a schematic diagram showing the modular ring mirror of FIG. 9A configured as a closed system. In FIG. 9B, a modular ring mirror 910 such as that in FIG. 9A is provided with cover layers 920, 930 which can be attached to the modular mirror ring 910 with any convenient attachment method. A seal (such as the O-ring seal shown in FIG. 10) can be provided to assure that there is no leakage into or out of the volume so defined between the modular mirror ring 910 and each of the cover layers 920, 930. A laser/detector can be connected hermetically to the aperture 960, so as to seal that aperture, or a transparent window can be attached to the aperture 960. In order to provide a specimen of interest for examination, inlet 940 and outlet 950, comprising the necessary tubing, valving, pumping apparatus and control apparatus can be provided. In some embodiments, the cover layers 920, 930 are thick enough that the inlet 940 and outlet 950 can be provided as radially oriented openings in each of the cover layers 920, 930, respectively.

Stacking these modular ring mirror 910 sections will enable tailoring analysis of a suite of molecules of interest. FIG. 10 illustrates a multi-ring stack and offers a robust system that can be readily used to detect chemicals of interest. The ring sections can be made very slim, on the order of the laser beam spot size which is nominally 2-4 mm, to minimize size and mass. In order to maximize the internal pathlength inside the cell, the laser beam configuration is set so that the beam is launched and received from the same port on the side of the absorption cell.

The cavity height can be made quite thin to allow for modular units for different wavelengths of interest, and the shallow cell depth can avoid wall effects sometimes encountered with cells of the linear configuration. As is the case with traditional Herriott cells, the mirror surfaces can be entirely spherical, or astigmatic, which produces dense Lissajous-type patterns that enable large path lengths. Like stable Herriott designs, the ring multipass cell is self-imaging and constantly re-focuses the propagating beam as it reflects from surface to surface. An example of a single channel ring cell with spherical surfaces is shown below in FIG. 9A. FIG. 10 is a multichannel system.

The envelope of the rays that trace out the pattern around the circumference of the cell lies in a plane. If an input ray is launched using compound angles with respect to the local coordinate system's X and Y axes, all rays still lie in a plane, but the plane is tilted due to the launch angle with reference to the X-axis.

The number of round trips inside the cavity can be varied by changing the injection angle of the laser beam.

Multiple rings may be stacked to target the desired number of chemical signatures as shown in FIG. 10. This multichannel configuration completely eliminates any cross talk or interference between channels because the paths the laser beams trace out on the interior surface of the rings are physically separated. The multiple rings can be connected using O-rings situated in O-ring grooves to provide a hermetic seal between rings. Multiple rings may be stacked to target the desired number of chemical signatures as shown in FIG. 10, with O-ring seals between successive rings, or with rings having closed configuration as shown in FIG. 9B provided for one or more of the multiple rings.

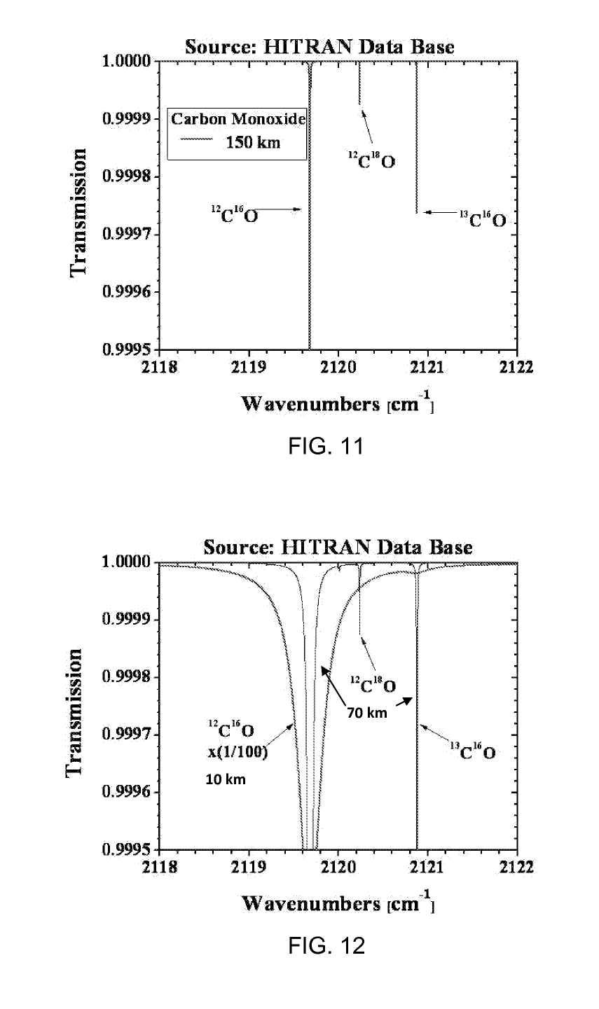

FIG. 11 is a graph illustrating the result of a spectral simulation of absorption by CO for various isotopes of carbon and oxygen at an altitude of 150 km in the atmosphere of Titan.

FIG. 12 is a graph illustrating the result of a spectral simulation of absorption by CO for various isotopes of carbon and oxygen at altitudes of 75 km and 10 km in the atmosphere of Titan.

FIG. 11 and FIG. 12 show spectral simulations over a 4 cm⁻¹ region in the 4.7 micron range that covers isotopic species of carbon and oxygen in CO. Different altitudes correspond to different gas densities or gas pressures. The most abundant isotope, ¹²C¹⁶O, should be observable in direct absorption throughout the probe descent using a 41 m path cell. The intensity of the ¹²C¹⁶O line has been reduced by a factor of 100 in the simulations in order to highlight expected absorption depths for ¹³C¹⁶O and ¹²C¹⁸, the less abundant isotopes. Important information about dynamics in the atmosphere can be gleaned from studying the isotopic ratios.

### Remote Sensing Applications

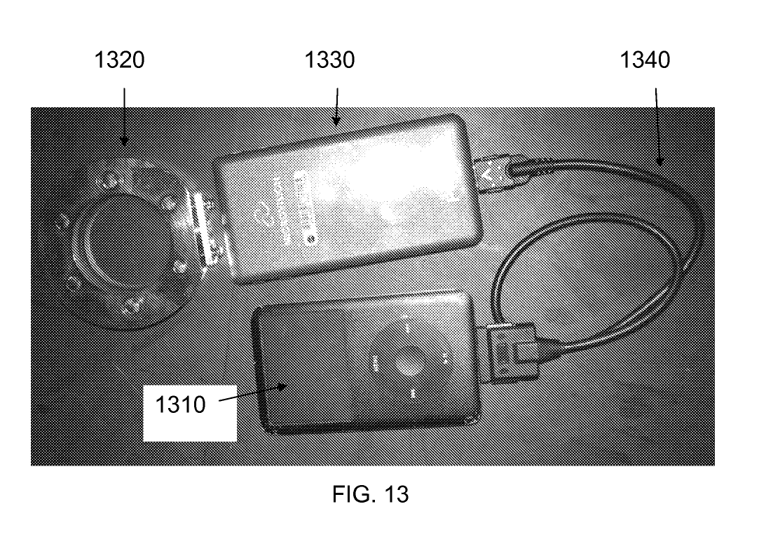

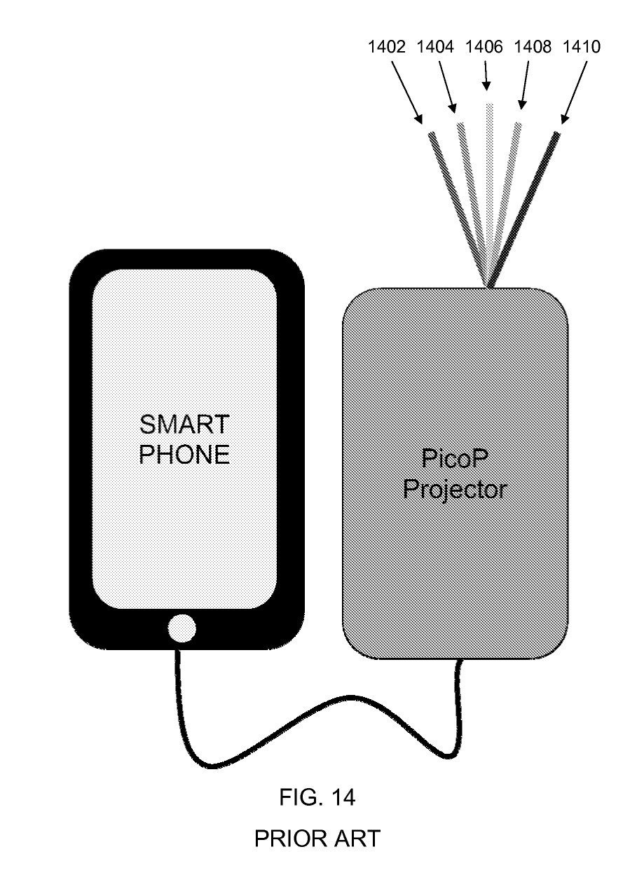

FIG. 13 is a diagram of an embodiment of a network-capable modular ring mirror laser sensor. In FIG. 13, numeral 1310 denotes a network capable microprocessor-based controller device such a cell phone or an iPod, numeral 1320 denotes a SLIMS modular ring mirror laser sensor, numeral 1330 denotes a modified MicroVision SHOWWX™ laser pico projector available from MicroVision, Inc., 6222 185th Ave NE Redmond Wash., 98052 USA, and numeral 1340 denotes an interconnect cable to connect the network capable microprocessor-based controller device 1310 and the projector 1330.

FIG. 14 is a schematic diagram showing a cell phone in communication with a PicoP projector. In FIG. 14, the numeral 1402, 1404, 1406, 1408 and 1410 denote laser radiation of different wavelengths (for example, visible red, visible orange, visible yellow, visible green and visible blue, or five different infrared wavelengths, respectively).

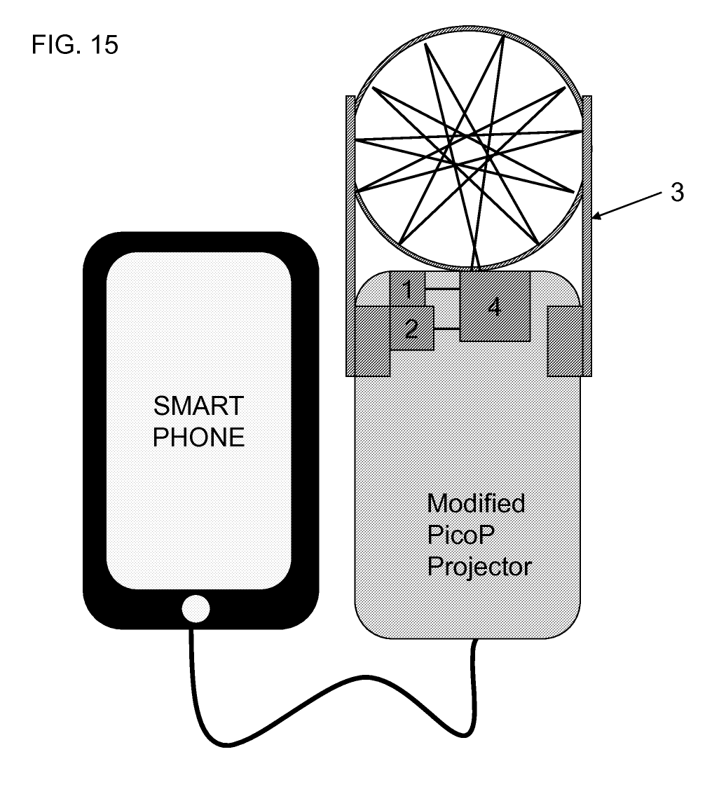

FIG. 15 is a schematic diagram showing a cell phone in communication with a PicoP projector having an attached modular ring mirror laser sensor. In FIG. 15 numeral 1 denotes a detector, numeral 2 denotes one or more QCL laser(s) wired into the PicoP projector amplifier, numeral 3 denotes a LSS integration fixture, and numeral 4 denotes a supporting optics bus.

It is expected that a remote sensing device having a communication channel configured to communicate over a network, a SLIMS spectrometer as described herein, and gas handling apparatus (either passive to allow a gas to diffuse into the SLIMS or active to move a gas sample into the SLIMS) can provide measured data on one or more species of interest as a function of time, with information about the location at which the measurement is recorded. As explained hereinabove, the remote sensing device can be configured to measure one species or a plurality of species of interest. The measured data can be recorded, analyzed, and displayed to a user in raw and/or analyzed form.

It is expected that smaller and lighter mirror rings can be constructed using materials such as aluminum, titanium, or carbon composite.

Extremely low detection limits will be readily obtained using second harmonic detection, which is widely used to monitor weak signals in magnetic resonance, Stark, and Zeeman spectroscopy. This technique has been utilized with scanning laser spectrometers to measure IR absorptions as low as 10⁻⁶. Modulation of the laser source at high frequency in the tens of kHz is achieved by applying a sinusoidal frequency on top of the current supply ramp. By analyzing the AC signal returned at the second harmonic frequency one can retrieve volume mixing ratios from second derivative line shapes. Detection at 2f provides a tremendous advantage of rejecting any DC or if low frequency noise on the spectrum and also removes slope on the background levels common for ramped laser scans.

Detection at twice the frequency modulation provides a significant improvement in the SNR and enables detection at the 10⁻⁶ level. Converting the measured response signal to a concentration requires accurate measurement of temperature, pressure, and the use of spectroscopic parameters of linecenter, linestrengths, line broadening parameters, laser linewidth, and tuning parameters. Converting the second harmonic signal to a volume mixing ratio is performed by fitting the recorded spectrum according to the modulation amplitude.

### DEFINITIONS

Unless otherwise explicitly recited herein, any reference to an electronic signal or an electromagnetic signal (or their equivalents) is to be understood as referring to a non-volatile electronic signal or a non-volatile electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A scanning laser infrared molecular spectrometer, comprising:
a modular ring mirror having defined therein a single aperture through which an input laser beam and an output beam both pass, said modular ring mirror having defined therein an inner reflective surface configured as a section of a sphere, said modular ring mirror having defined therein a volume configured to contain a gas sample to be measured to determine at least one of a presence of a substance of interest and a concentration of said substance of interest;
a laser configured to provide a beam of illumination having an intensity Iᵢₙ and a wavelength λ in the infrared, said laser aligned relative to said modular ring mirror so as to provide said beam of illumination as said input laser beam;
a detector configured to detect illumination having said wavelength in the infrared and configured to provide at an output terminal thereof an electrical signal representative of an intensity Iₒᵤₜ of said detected illumination at said wavelength in the infrared, said detector aligned relative to said modular ring mirror so as to receive said beam of illumination as said output beam; and
an analyzer configured to receive said electrical signal representative of said intensity Iₒᵤₜ of said detected illumination at an input terminal thereof, and to determine a result comprising at least one of said presence of said substance of interest and said concentration of said substance of interest based on said electrical signal, and configured to perform at least one of recording said result, displaying said result to a user, and transmitting said result to another apparatus for further use.

2. The scanning laser infrared molecular spectrometer of claim 1, wherein said modular ring mirror is a monolithic ring mirror.

3. The scanning laser infrared molecular spectrometer of claim 1, wherein said modular ring mirror having defined therein a volume configured to contain a gas sample to be measured comprises a volume open to ambient atmosphere.

4. The scanning laser infrared molecular spectrometer of claim 1, wherein said modular ring mirror having defined therein a volume configured to contain a gas sample to be measured comprises a volume closed to ambient atmosphere.

5. The scanning laser infrared molecular spectrometer of claim 1, wherein said modular ring mirror and said laser are configured to be mutually oriented so as to define an optical path length defined by the relation Path Length (PL)=(ring diameter)×(180−α)/2α and α is an angle of incidence of said input laser beam relative to a center of said single aperture of said modular ring mirror.

6. The scanning laser infrared molecular spectrometer of claim 1, wherein said laser is a quantum cascade laser.

7. The scanning laser infrared molecular spectrometer of claim 1, wherein said laser is configured to be tuned to a desired wavelength λ_{d}.

8. The scanning laser infrared molecular spectrometer of claim 1, wherein said detector is a thermoelectrically cooler detector.

9. The scanning laser infrared molecular spectrometer of claim 1, wherein said analyzer configured to perform at least one of recording said result, displaying said result to a user, and transmitting said result to another apparatus for further use is configured to transmit said result using a communication network.
